(19) United States
(12) Patent Application Publication
(10) Pub. No.: US 2004/0025522 A1
(43) Pub. Date: Feb. 12, 2004

(54) Method and an apparatus for the temperature controlling of air in at least two regions of a space

(76) Inventors: Jean-Claude Petesch, Kehlen (LU); Hartmut E. Van Hauten, Mainz (DE); Mark Matthew Gallagher, Sterling Heights, MI (US)

Correspondence Address: PATRICK M. GRIFFIN, DELPHI TECHNOLOGIES, INC., P.O. Box 5052, Legal Staff, Mail Code: 480-410-202, Troy, MI, 48007-5052, US

(21) Appl. No.: 10/429,273

(22) Filed: May 2, 2003

(30) Foreign Application Priority Data
Aug. 8, 2002 (DE) 10236457.5

(51) Int. Cl. F25D 17/00; B60H 1/00

(52) U.S. Cl. 62/179; 165/203

(57) ABSTRACT

In a method for the control of the strength and the temperature of at least two temperature controlled air flows which serve for the temperature control of at least two corresponding regions of a space and which are generated by making available a cold air flow and a hot air flow whose temperatures can be controlled individually and/or whose strengths can be controlled individually or in combination, by forming in each case a cold air regional part flow and a hot air flow for each of the regions from the cold air flow and the hot air flow, by respective restriction or additional supply of the regional part flows by respectively corresponding, controllable restrictor devices or at least one additional supply device and mixing of corresponding regional part flows for the respective regions, a desired temperature and a desired strength of an air flow to be supplied to the region are set for each of the regions and the strength of the cold air flow and/or of the hot air flow and/or at least one of the restrictor devices or the additional supply device are controlled in dependence on all set desired temperatures and desired strengths such that the respective temperature controlled air flow substantially has the pre-set desired temperature and the preset flow strength for each of the regions.

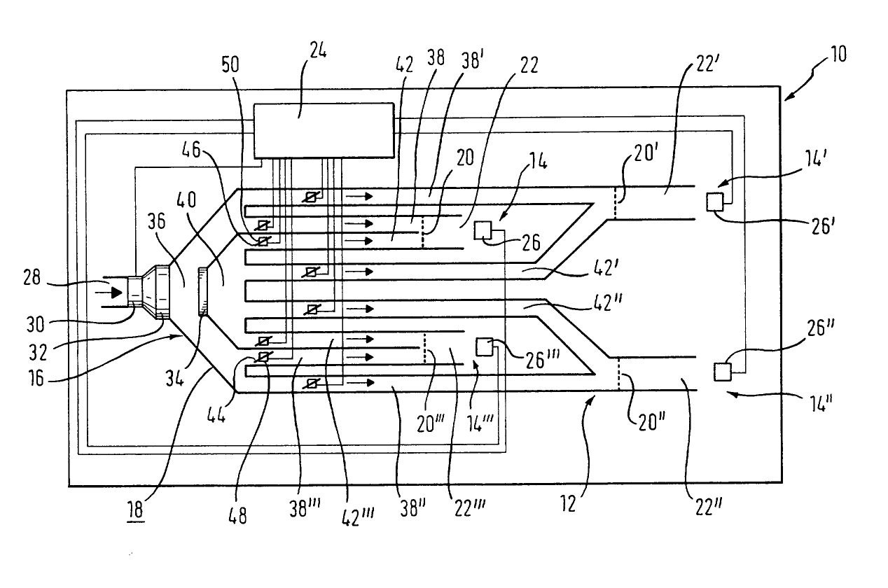

### TECHNICAL FIELD

The present invention relates to a method for the controlling of the strength and the temperature of at least two temperature controlled air flows, to a method for the controlling of the temperature of air for at least two regions of a space, in particular of the passenger compartment of a motor vehicle, and to a corresponding supply apparatus to make air flows available to at least two regions of a space.

### BACKGROUND OF THE INVENTION

Modern motor vehicles are frequently fitted with air conditioning devices by means of which the air in a passenger compartment of the motor vehicle can be temperature controlled. To take the different heat sensitivity of different occupants into account, it is desirable for different regions of the compartment to be able to be individually temperature controlled. For this purpose, detection devices can be provided for the different regions by means of which a wanted desired temperature and a desired strength of an air flow to be supplied to the respective region for climate control can be pre-set by an occupant.

For reasons of simplicity, all air flows to feed the regions are usually formed from hot air and cold air from a common source. This has the result that, on changing the settings for one region, the air flows for other regions are also changed by the changing flow relationships. These changes can then be unpleasant for the occupants in the other regions and require a change of the settings for these regions.

One way out is to make available a separate hot air source and cold air source for each region. The technical complexity and the costs associated with this are, however, not tolerable for example for applications in a motor vehicle.

### SUMMARY OF THE INVENTION

It is therefore the underlying object of the present invention to provide methods and means to supply at least two different regions of a space in a simple manner with properly controlled air of a pre-set temperature and strength in each case.

The object is satisfied by a method for the controlling of the strength and temperature of at least two temperature controlled air flows which serve for the temperature controlling of at least two corresponding regions of a space, in particular of a passenger compartment of a motor vehicle, having the features of claim 1.

The method in accordance with the invention for the control of the strength and the temperature of at least two temperature controlled air flows which serve for the temperature controlling of at least two corresponding regions of a space, in particular of a passenger compartment of a motor vehicle and which are produced by making available a cold air flow and a hot air flow whose temperatures can be controlled individually and/or whose strengths can be controlled individually or in combination, by forming a respective cold air regional part flow and hot air regional part flow for each of the regions from the cold air flow and the hot air flow, by a respective restricting or additional supplying of the regional part flows by respective corresponding controllable restrictor devices and/or at least one additional supply device and by mixing corresponding regional part flows for the respective regions provides that a desired temperature and a desired strength of an air flow to be supplied to the region are set for each of the regions and that the strength of the cold air flow and/or of the hot air flow and/or at least one of the restrictor devices or the additional supply device are controlled in dependence on all desired temperatures and desired strengths which have been set such that the respective temperature controlled air flow substantially has the pre-set desired temperature and the pre-set desired flow strength for each of the regions. This method in accordance with the invention will also be termed a control method in the following.

The object is furthermore satisfied by a method for the temperature control of air in at least two regions of a space, in particular of a passenger compartment of a motor vehicle, having the features of claim 10.

With the method in accordance with the invention for the temperature control of air for at least two regions of a space, in particular of a passenger compartment of a motor vehicle, a cold air flow and a hot air flow are made available whose temperatures can be controlled individually and/or whose strengths can be controlled individually or in combination. At least one regional part flow is formed for each of the regions from the cold air flow and the hot air flow respectively and the corresponding regional part flows are restricted and mixed for each respective region by means of a corresponding controllable restrictor device and/or an additional supply device, with the strength of the cold air flow and/or of the hot air flow and/or the restrictor devices and/or the additional supply device being controlled with the method for control in accordance with the invention.

The object is further satisfied by a supply apparatus to make available air flows for at least two regions of a space, in particular of a passenger compartment of a motor vehicle, with a respective strength and temperature specific to the region having the features of claim 14.

The supply apparatus in accordance with the invention for the making available of air flows for at least two regions of a space, in particular of a passenger compartment of a motor vehicle, with a respective strength and temperature specific to a region includes a cold air source and a hot air source, by means of which a cold air flow and a hot air flow can be generated whose temperatures can be controlled individually and/or whose strengths can be controlled individually or in combination and can be discharged via a cold air outlet or a hot air outlet of the cold air source and the hot air source; branching passages connected to the cold air outlet or to the hot air outlet having controllable restrictor devices and/or at least one additional supply device by means of which cold air regional part flows and hot air regional part flows can be made available in a separately controllable manner for each of the regions from the cold air flow or from the hot air flow; at least one detection device for the detection of a desired temperature and a desired strength respectively of the air flow to be supplied separately to the respective region; a control device connected to the detection device for the control of the cold air source and of the hot air source and of the restrictor devices and/or of an additional supply device in dependence on the desired temperatures and desired strengths of the air flow for the regions, by means of which the cold air source and the hot air source and the restrictor devices and/or the additional supply device can be controlled in dependence on the desired temperatures and/or on the desired strengths of the air flows for the regions such that the strengths and the temperatures of the air flows for all regions substantially coincide with the desired strengths and the desired temperatures for these regions.

The method in accordance with the invention of controlling the temperature of air can be carried out with the apparatus in accordance with the invention, provided that the control device is designed to carry out the control method in accordance with the invention.

Provision is made in the method in accordance with the invention first to make available a cold air flow and a hot air flow whose temperatures can be controlled individually and/or whose strengths can be controlled individually or in combination. For this purpose, with the apparatus in accordance with the invention, a cold air source and a hot air source are provided with which corresponding flows can be made available. Although a control of the temperature alone or in combination with a control of the strength of the cold air flow and the hot air flow is generally provided, appropriately usually only a control of the strength is carried out, since a temperature control can be comparatively complex in motor vehicles. The strengths of the cold air flow and of the hot air flow can be controlled individually. However, it is also possible to control the strengths in combination, i.e. to control only the sum of the strengths of the cold air flow and of the hot air flow, i.e. their total strength.

In the context of the invention, the strength of an air flow can be understood as a value corresponding to a mass flow or to a volume flow of the air flow.

At least one cold air regional part flow and one hot air regional part flow are then formed for each of the regions from the cold air flow and the hot air flow. In the supply apparatus in accordance with the invention, branching passages, in which the regional part flows can be formed by the branches and can then be further guided, are connected for this purpose to a cold air outlet or a hot air outlet respectively of the cold air source or of the hot air source respectively.

To control the strength of the cold air regional part flows and of the hot air regional part flows for the respective regions, restrictor devices and/or at least one additional supply device are provided by means of which the corresponding regional part flows can be restricted or additionally amplified. The additional supply device can in particular be a controllable additional fan.

To form the temperature controlled regional part flows, the respective cold air regional part flows and the hot air regional part flows are mixed with one another, with a temperature controlled air flow resulting with a temperature and a strength which result from, among other things, the temperatures and strengths of the regional part flows.

To be able to control the temperature and the strength of the temperature controlled air flows, first desired temperatures and desired strengths of the air flows are set for the respective regions, with the setting of these desired values being able to take place by a user or automatically, for example by control or regulating devices.

The supply apparatus in accordance with the invention has, for this purpose, at least one detection device for the detection of a respective desired temperature and desired strength of the air flow to be supplied to the respective region. Generally, the detection device can have an electrical or an electronic interface via which, for example, an automatic control device sets corresponding desired temperatures and/or desired strengths in response to signals from temperature sensors and/or in dependence on times of day. It can however, also include corresponding control devices itself.

Alternatively or additionally, however, corresponding input members, for example knobs or slides, can be provided for each of the regions whose movement or position can ultimately be converted into electrical values which then serve to set desired temperatures and desired strengths. In the latter case, the desired temperature and the desired strength do not necessarily have to be input as physical values for the user. Any other desired scaling can rather be used for the user which can then be converted into values suitable for the control by means of a characteristic curve for the input member. In particular when operated by a user, a plurality of detection devices can be provided which can expediently be arranged close to the regions to be temperature controlled.

In this connection, the setting of the desired temperatures and of the desired strengths can take place, on the one hand, with a detected operation of a detection member or with a signal of the control device. However, the position of the detection members can also be queried or detected repeatedly, in particular periodically.

In accordance with the invention, the strength and/or the temperature of the cold air flow and of the hot air flow and the strength of at least one restrictor device and/or additional supply device are controlled in dependence on all set desired temperatures and desired strengths such that the temperature controlled air flow substantially has the respective pre-set desired temperature and the desired current strength for each of the regions.

In this connection, the fact that a temperature controlled air flow substantially has the pre-set desired temperature and the pre-set desired strength means that the temperature or the strength of the air flow achieved by the control differ from the desired temperature or from the desired strength at most by a preset maximum error which is preferably smaller than 10% with regard to the respective desired value. The maximum error is preferably smaller than 5%. Alternatively, the maximum error can also be given as the maximum absolute difference.

The apparatus in accordance with the invention has a control device for the control which includes inputs connected to the detection device and outputs connected to the restrictor devices or to the additional supply devices and the cold air sources or the hot air sources and which is preferably formed to carry out the control process in accordance with the invention.

The large advantage in particular results by this control that, independent of changes in the desired temperature and/or in the desired strength of an air flow for one region, the desired temperature and the desired strength of the air flow for another region can substantially, i.e. in accordance with the aforesaid error intervals, be kept constant.

A very precise and reliable control of the supply of the different regions with temperature controlled air thus results in a simple manner without further complex and/or expensive cold air sources or hot air sources being necessary. Furthermore, with an expedient design of the control, a complex and/or expensive regulation can be omitted, which would require corresponding sensors for the temperature controlled air flows.

Further developments and preferred embodiments of the invention are described in the description, in the claims and in the drawings.

It is admittedly frequently desirable to supply a region with air of a pre-set desired temperature, but to supply part regions of the region, for example a head space or a foot space, with air flows of different strengths for the part regions. It is therefore preferred in the control process in accordance with the invention for at least one of the regions, for which a first of the two temperature controlled air flows is provided, to be divided into two part regions; for the strengths of at least two part region air flows for the part regions which are formed by a splitting of the first temperature controlled air flow and by a restricting of the part region air flows by respectively corresponding, controllable restrictor devices to be controlled; for a common desired temperature and respectively one desired strength of the part region air flows to be set instead of the desired temperature and the desired strength of the first air flow and for the desired strength of the first air flow to be determined from the desired strengths of the part region air flows and its desired temperature to be determined from the common desired temperature; and for the strength of the cold air flow and/or of the hot air flow and/or at least one of the restrictor devices and/or the additional supply device additionally to be controlled in dependence on the set desired strengths of the part region air flows such that the temperature controlled air flow or the part region air flow respectively substantially has the pre-set desired temperature and the pre-set desired strength for each of the regions and part regions. The control of the air flow of the region divided into part regions is therefore substantially maintained, with its desired strength, however, being determined from the desired strengths of the part region air flows.

With the method in accordance with the invention for the temperature control of air, it is preferred for at least one of the regions, for which a first of the two temperature controlled air flows is provided, to be divided into two part regions; for two part region airflows to be formed for the two part regions from the first temperature controlled air flow and to be restricted by respectively corresponding, controllable restrictor devices, with the strength of the cold air flow and/or of the hot air flow and/or the throttle devices and/or the additional supply device to be controlled with the just mentioned control method in accordance with the invention.

It is preferred in the supply apparatus in accordance with the invention for the supply apparatus to be designed for the making available of two equally temperature controlled part region air flows for two part regions of one of the regions, instead of one temperature controlled air flow for this region; for branching passages for cold air and hot air provided for this region to open into a passage which branches into part region passages in which a controllable restrictor device connected to the control device is respectively arranged; for the detection device to be designed to detect desired strengths and a common desired temperature of the part region air flows instead of to detect the desired strength and the desired temperature of the air flow to be supplied to the region; for the control device to control the cold air source and the hot air source and the restrictor devices and/or the additional supply device in dependence on the desired temperatures and on the desired strengths of the air flows for the regions and part regions, by means of which the cold air source and the hot air source and the restrictor devices and/or the additional supply device to be controllable in dependence on the desired temperatures and/or the desired strengths of the air flows for the regions and the part regions such that the strengths and the temperatures of the air flows or all regions and part regions substantially agree with the desired strengths and the desired temperatures for these regions.

Generally, the control device of the supply apparatus in accordance with the invention can be made as a fixed analog or digital circuit with which the control method in accordance with the invention can be carried out. It is, however, preferred for the control device to have an interface for the detection device and interfaces for the cold air source and the hot air source, the restrictor devices and/or the additional supply device, a memory device and a processor connected to the interfaces and the memory device, with a program executable by the processor being stored in the memory device to carry out the control process in accordance with the invention. Such a control device can then be used in the same form even with a varying design of the remaining supply apparatus; only the program has to be respectively adapted.

It is preferred with the methods in accordance with the invention, in particular with a change of a desired temperature and/or of a desired flow strength, for the strength of the restriction or of the additional supply of all regional part flows, where appropriate, the strength of the restriction of the part region air flows, and the strengths and/or temperatures of the cold air flow and of the hot air flow to be controlled using a model which links the desired temperatures and desired flow strengths for the regions or part regions with the strengths of the restriction or of the additional supply of all regional part flows required to achieve these values, where appropriate, the strengths of the restriction of the part air flows and the strengths and/or temperatures of the cold air flow and of the hot air flow. These models can generally be any desired representations by means of which the desired temperatures and the desired flow strengths can be determined for the regions or part regions with the strengths of the restriction and of the additional flow of all regional part flows or the strengths of the restriction of the part region air flows and the strengths and/or temperatures of the cold air flow and of the hot air flow required to achieve these values.

In a particularly preferred embodiment, the models used can in particular be based on physical, technical flow and/or thermodynamic laws and be given by corresponding parameterized model equations or mathematical relationships. The models can each in particular also have parameters which depend in a known manner on the characteristic values of individual components, in particular for restrictor devices, with the strengths of the restriction or of the additional supply of all regional part flows and the strengths and/or temperatures of the cold air flow and of the hot air flow required to achieve these values being able to be calculated afresh in each case for set desired temperatures and desired flow strengths, which can, however, require substantial calculation effort with complex models based on physical, technical flow and/or thermodynamic relationships.

It is therefore preferred for characteristic fields to be pre-set by which—for pre-set desired temperatures and desired flow strengths for the temperature controlled air flow for the regions and/or, where present, for the part regions—the strengths and/or temperatures of the cold air flow and of the hot air flow and of the strengths of the restriction or of the additional supply of the individual regional part flows and/or the strengths of the restriction of the part region air flows required to achieve these desired values are given and for the strength of the restriction and the additional supply of all regional part flows and/or the restriction of the part region air flows and the strengths and/or temperatures of the cold air flow and of the hot air flow to be controlled using the characteristic field, in particular with a change in a desired temperature and/or a desired flow strength.

The characteristic fields can in particular be simple input-output models which were previously obtained by suitable measures. These can in particular also be provided by suitable parameterized models which are obtained simply as a representation of the required dependencies without a derivation from a technical physical relationship. Multi-dimensional polynomial models, for example on the basis of splines, can in particular be used.

With the apparatus in accordance with the invention, it is preferred with respect to the use of characteristic fields for at least one characteristic field to be storable in a memory device to carry out the control method in accordance with the invention, with the characteristic field being able to be stored, for example, in the form of parameters for the characteristic field on presentation by splines in the form of corresponding spline coefficients; it can, however, also be stored in discrete form in the manner of a look-up table. A particularly simple and fast determination of the strength of the restriction or of the additional supply of all regional part flows or, where present, the strength of the restriction of the part region air flows and of the strength and/or temperature of the cold air flow and of the hot air flow is thus achieved.

With the use of a discretely stored characteristic field, it is preferred—in particular with a change of a desired temperature and/or a desired flow strength for one region—for the strength of the restriction or of the additional supply of at least one regional part flow or the strength of the restriction of at least one part region air flow and the strengths and/or temperatures of the cold air flow and of the hot air flow to be obtained by interpolation or extrapolation from the discrete characteristic field. In this way, with a given support position number of the characteristic field, a higher precision and/or resolution of the model can be achieved with respect to the independent variables. With a given precision, the required memory effort can contrariwise be reduced.

The models can be obtained beyond the already mentioned way in further different manners.

With an embodiment of the method in accordance with the invention, it is preferred for the model to be obtained using measurements at an existing supply apparatus. The model can in particular be given by characteristic fields in the above sense, with the strengths of the restriction or of the additional supply of all regional part flows and/or of the restriction of the part region air flows and the strengths and/or temperatures of the cold air flow and of the hot air flow being varied either with pre-set desired temperatures and/or desired flow strengths for the regions or, where applicable, desired strengths of the part regions, such that the desired values are reached. A suitable model can then be matched to the data obtained by matching of the structure of the model, or also in particular existing parameters. Alternatively, the strengths of the restriction or of the additional supply of all regional part flows or, where applicable, of the strengths of the part region air flows and the strengths and/or temperatures of the cold air flow and of the hot air flow can also be systematically varied and the resulting temperatures and strengths of the air flows can be determined for the regions. The characteristic field can then be obtained, for example in a discrete form, by inverting the relationship.

Alternatively or additionally to this, it is preferred for the model to be obtained by simulation computations. For this purpose, numerical computation methods of fluid mechanics or fluid dynamics (computational fluid dynamics) can be used in which the flow and temperature relationships are calculated in a computational model of the supply device in dependence on the restriction or the additional supply of all regional part flows or on the restriction of the part region air flows and on the strengths and/or temperatures of the cold air flow and of the hot air flow, with it generally being possible to proceed in a similar way as with the use of measurements to prepare a characteristic field.

The cold air source and the hot air source can in particular be formed by a source for an air flow, a cooling device and a heating device, with the cooling device and/or the heating device generally being able to be any desired devices to cool or to heat air. Known evaporators connected to a refrigerant circuit or heating cores which are heatable electrically via fuel or a cooling circuit of a combustion engine can in particular be used as the cooling devices or the heating devices.

The strength of the cold air flow and of the hot air flow can generally be controllable independently of one another, in particular on the use of a cold air source and a hot air source with a cold air source ad a hot air source independent of this. Such supply devices are, however, complex as a rule. It is therefore preferred for the cold air flow and the hot air flow to be formed jointly by means of a controllable fan or, with the control method in accordance with the invention, for the supply performance of a fan jointly generating the cold air flow and the hot air flow to be controlled to control the strength of the cold air flow and of the hot air flow. With the supply apparatus in accordance with the invention, it is preferred for this purpose for the cold air source and the hot air source to have a fan with a controllable supply performance for the supply of air to be temperature controlled and for the strength of the cold air flow and of the hot air flow to be controllable by control of the supply performance of the fan. A simple control of the strength of the cold air flow and of the hot air flow thus results, with control also being understood in the sense of the invention such that the actually resulting cold air flow and hot air flow can vary depending on the strength of the following restrictions with a given controlled supply performance.

In this connection, it is particularly preferred for the hot air flow to be formed from at least one regional part flow of the cold air flow. It is preferred with the supply apparatus in accordance with the invention for the hot air flow source to be arranged downstream of the cold air source and to be feedable by cold air formed from the cold air source, with the cold air source being arranged downstream of the fan and being supplied from this with air to be cooled. The heating after previous cooling results in a very dry hot air which is very well suited to eliminate fog or ice on windows of a motor vehicle. Furthermore, a very simple design of the supply apparatus in accordance with the invention results.

To facilitate the installation of the supply apparatus in accordance with the invention into a motor vehicle, it is preferred for the cold air source and the hot air source, the restrictor devices and/or the additional supply unit and sections of the branching passages up to these devices to be combined to form one component. If part region passages with restrictor devices arranged thereon are provided, at least the sections of the part region passages up to the restrictor devices and the restrictor devices are preferably likewise combined in the component. The number of the electrical connections or air passages required on the installation, for example into a motor vehicle, is largely reduced in this manner. The cold air source and the hot air source and the restrictor devices and/or the additional supply device are particularly preferably arranged in a common housing, with the housing in particular also being able to be of modular design.

Additional supply devices in the form of controllable additional fans and/or a restrictor device can generally be used to generate a regional part flow independently of the kind of generation of the other regional part flows. It is, however, preferred for the respective strengths of the regional part flows to be set by control of the restriction by means of corresponding controllable restrictor devices and without control of an additional supply. The supply apparatus in accordance with the invention or another supply apparatus controllable by the control method in accordance with the invention in this case does not have any additional supply devices, whereby not only its design is substantially simplified, but also the energy take-up and the noise development are considerably reduced.

The restrictor devices can generally be of any desired design. In an embodiment of the invention, however, it is preferred for at least one restrictor device to be formed by a section of the corresponding branching passage connected to a corresponding outlet of the cold air source and the hot air source and by a throttle valve arranged in the section or at one of its ends whose position is controllable. The throttle valve is particularly preferably movable by a corresponding actuator which can optionally have a position acknowledgement, with the throttle valve being adjustable in steps or, preferably, continuously.

It is furthermore preferred with the supply apparatus in accordance with the invention for at least one restrictor device to have a controllable film valve. A film valve is here understood as a restrictor device with which a feedthrough opening, for example of the branching passage, is bridged by a flexible, areal element, for example a film, a foil or a tape, which has at least one opening in the form of a window and is movable by an actuator such that the window is movable at least partly into the region of the feedthrough opening and that a controllable valve opening is provided by the overlapping region of the window and the feedthrough opening. The window is preferably also fully movable out of the region of the feedthrough opening. The flexible, areal element can in particular be supported in part by two roller or roll elements which can be driven in different directions of rotation in a controlled manner and by means of which it can be moved. The branching passage between the cold air source and the hot air source and the film valve can in particular also be formed in a chamber-like manner. Film valves of this kind, and in particular preferred embodiments of the same and cold air sources and hot air sources with branching passages and film valves in different embodiments, which can be used within the framework of the invention, are described in U.S. Pat. No. 6,273,811 B1 whose contents are herewith incorporated into the description by reference.

A further subject of the invention is a computer program with program code means to carry out the method in accordance with the invention when the program is executed on a computer. A computer is here in particular also understood as a processor or a microcontroller with a memory connected to it or integrated with it. The control device of the supply apparatus in accordance with the invention is in particular also to be understood as a computer in this sense.

A subject of the invention is furthermore a computer program product with program code means which are stored on a computer readable data carrier to carry out the methods in accordance with the invention when the computer program product is carried out on a computer.

### BRIEF DESCRIPTION OF THE DRAWINGS

The invention will be further explained in the following by way of example with reference to the drawing.

The only FIGURE shows a schematic representation of an air conditioning unit in a motor vehicle in accordance with a preferred embodiment of the invention.

### DESCRIPTION OF THE PREFERRED EMBODIMENT

In the Figure, a supply device 12 is arranged in a motor vehicle 10 by means of which an air flow with a pre-set strength and temperature specific to the region can be supplied to regions 14, 14′, 14″ and 14′″ inside a passenger compartment of the motor vehicle 10.

The supply apparatus 12 includes for this purpose shown only very schematically in the FIGURE a supply module 16 comprising a housing 18 with four outlets 20, 20′, 20″, 20′″ for temperature controlled air and with feed lines 22, 22′ 22″ and 22′″ to the respective regions 14, 14′, 14″ and 14′″ connected to the outlets 20, 20′, 20″ and 20′″ .

Furthermore a control unit 24 and input devices 26, 26′, 26″, 26′″ connected to the control unit 24 are provided in the regions 14, 14′, 14″, 24′″ for control.

In the housing 18, the supply module 16 has an air inlet 28, a fan 30 arranged downstream of the air inlet 28, an evaporator 32 and a heating core 34.

A conventional fan is used as the fan 30 whose delivery is controllable by a change in an operating voltage of a drive motor not shown in the Figure. For this purpose, the fan 30 is connected to a corresponding output of the control unit 24.

The evaporator 32 is a conventional evaporator having a conventionally driven refrigerant circuit for a refrigerant (not shown in the Figure), by means of which air supplied to it by the fan 30 and passing through it is cooled.

A likewise conventional heating core is provided as the heating core 34 and heats air passing through it using cooling water which is supplied to it from a cooling of the combustion engine.

A cold air chamber 36 is formed between the evaporator 32 and the heating core 34 and branches, on the one hand, into cold air passages 38, 38′, 38″ and 38′″ to one each of the regions 14, 14′, 14″ and 14′″ and, on the other hand, opens into an inlet of the heating core 34.

A hot air chamber 40 is formed downstream of the heating core 34 and opens into hot air passages 42, 42′, 42″ and 42′″ for one each of the regions 14, 14′, 14″ and 14′″.

Throttle flaps are respectively arranged in the cold air passages 38, 38′, 38″ and 38′″ and in the hot air passages 42, 42′, 42″, 42′″, of which for reasons of clarity only the throttle flaps 44 and 46 are provided with reference numerals.

The throttle flaps are each substantially continuously adjustable by actuators, of which, again, only the actuators 48 and 50 are characterized by reference numerals, between a closed position in which the corresponding passage is closed and an open position in which the corresponding passage is opened to a maximum.

The actuators are each connected to a corresponding output of the control unit 24 so that, by controlling the actuators, the position of the throttle flaps, and thus of the restrictor resistance, can be controlled by restrictor devices formed by the throttle flaps and the corresponding passages which contain them.

The cold air passages 38, 38′, 38″ and 38′″ and the hot air passages 42, 42′, 42″ and 42′″ corresponding to the respectively same regions 14, 14′, 14″ or 14′″ open into the common outlets 20, 20′, 20″ or 20′″ or into the feeders 22, 22′, 22″, 22′″ to the regions 14, 14′, 14″ or 14′″ connected thereto, where cold air and hot air discharged from the passages is mixed to form temperature controlled air.

The input devices 26, 26′, 26″ and 26′″ arranged in a respective one of the regions 14, 14′, 14″ or 14′″ are connected to corresponding inputs of the control unit 24 and respectively serve for the detection of desired temperatures and desired flow strengths for temperature controlled air flows which are to be supplied to the corresponding regions from the supply apparatus 12. They are made as digital input apparatuses with which a user can select a wanted desired temperature or desired flow strength from a discrete set of possible values by a single or multiple pressing of a corresponding button.

The control unit 24 serves for the control of the supply apparatus 12, i.e. in particular of the operating voltage of the fan 30 and of the actuators of the throttle flaps in the passages 38, 38′, 38″ and 38′″ or 42, 42′, 42″ and 42′″, in dependence on the desired temperatures and/or desired flow strengths input at the input devices 26, 26′, 26″ and 26′″.

For this purpose, it includes—not shown explicitly in the Figure a processor connected to the inputs and the outputs via corresponding interfaces and a memory device connected to the processor in which a control program to be executed on the processor and data described in the following and required for the execution of the control program are permanently stored, on the one hand, and temporary data can be stored, on the other hand.

In operation, air is transported by means of the fan 30 from the air inlet 28 through the evaporator 32 into the cold air chamber 36 with a capacity corresponding to the operating voltage, with a cold air flow being formed optionally while condensing air moisture.

In the cold air chamber 36, the cold air flow created is split into cold air regional part flows in the cold air passages 38, 38′, 38″ and 38′″ and into a portion which is guided through the heating core 34 into the hot air chamber 40 and is thereby heated while forming a hot air flow.

The hot air flow is then divided into corresponding hot air regional part flows in the hot air passages 42, 42′, 42″ and 42′″.

After dispensing the cold air regional part flows and the hot air regional part flows in the cold air passages and hot air passages 38, 38′, 38″ and 38′″ or 42, 42′, 42″ and 42′″ respectively by means of the throttle flaps arranged therein and controlled by the control unit 24, regional part flows associated with one another are respectively mixed at the openings of the corresponding passages while forming temperature controlled air flows and are supplied to the corresponding regions 14, 14′, 14″ and 14′″ through the feeders 22, 22′, 22″ and 22′″.

The control of the operating voltage for the fan 30 and of the actuators and thus of the positions of the throttle flaps for specific desired temperatures and desired flow strengths of the air flows for the four regions 14, 14′, 14″ and 14′″ takes place using corresponding characteristic fields which each have the desired temperatures and desired flow strengths of all four regions as independent values.

To achieve the simplest possible representation of the characteristic fields, it is not the operating voltage for the fan 30 or the actuator control voltage or signals for the respective actuator, but rather the performance of the fan 30 and of the flow resistance of the restrictor devices with a given position of the throttle flaps and/or of the actuator which are used as dependent variables.

The operating voltage and the control voltage or the actuator control signals then result with the help of a corresponding characteristic line for the fan 30 which put the delivery of the fan 30 into relationship to its operating voltage and of corresponding characteristic lines for the restrictor devices which puts the actuator control voltage or the actuator control signals and thus the position of the throttle flap into relationship with the flow resistance of the restrictor device.

Each of the characteristic fields is given by multi-dimensional cubic splines, with the dimension of the splines resulting from the number of independent values, that is the number of the regions multiplied by the number of the desired values per region, that is eight in the example.

Coefficients of the splines stored in the memory device are determined by adaptation to a sufficiently large number of suitably distributed data points inside and/or at the edge of the value range later used for desired temperatures and desired flow strengths, said data points being previously obtained by fluid dynamic simulation computations (CFD computations) for the supply apparatus 12. With these calculations, desired temperatures and desired flow strengths of the air flow are respectively pre-set for all four regions and the delivery of the fan 30 required to achieve these desired temperatures and desired flow strengths and the required flow resistances of the restrictor device are computed. If a plurality of solutions occur in the simulation computations, that solution is used which results in the smoothest characteristic field, i.e. the characteristic field with the lowest maximum gradients. To further increase the accuracy, trials can optionally be carried out with the real supply device 12.

For the control, the desired temperatures and the desired strengths are detected for all four regions 14, 14′, 14″ and 14′″ in pre-set time intervals of approximately 1 s. The required delivery of the fan 30 and the flow resistance of the restrictor device are then computed in the control unit 24 using the characteristic fields.

An operating voltage to be controlled for the fan 30 and actuator control voltages or signals for the actuators of the throttle flaps are thereupon calculated by means of the corresponding characteristic lines and the fan 30 and the actuators are controlled accordingly.

It can be ensured by the calculation of the delivery of the fan and of the flow resistance of the restrictor device, in each case in dependence on the desired temperatures and desired flow strengths of all regions 14, 14′, 14″ and 14′″, that even with a dramatic change, for example, of only one desired temperature, the throttle flap positions and the operating voltage of the fan 30 are controlled such that the temperatures and the flow strengths of the air flows to the other regions remain substantially, i.e. within the framework of the accuracy of the characteristic field here, unchanged and thus no loss of comfort or the necessity of a subsequent regulation by the user or users occurs.

1. A method for the control of the strength and the temperature of at least two temperature controlled air flows which serve for the temperature control of at least two corresponding regions (14, 14′, 14″, 14′″) of a space, in particular of a passenger compartment of a motor vehicle, and which are generated by making available a cold air flow and a hot air flow whose temperatures can be controlled individually and/or whose strengths can be controlled individually or in combination, by forming in each case from the cold air flow and the hot air flow a cold air regional regional part flow and a hot air regional regional part flow for each of the regions (14, 14′, 14″, 14′″), by respective restriction or additional supply of the regional regional part flows with respectively corresponding, controllable restrictor devices (44, 46, 48, 50) or at least one additional supply device and mixing of corresponding regional part flows for the respective regions (14, 14′, 14″, 14′″), in which
a desired temperature and a desired strength of an air flow to be supplied to the region are set for each of the regions (14, 14′, 14″, 14′″); and
the strength of the cold air flow and/or of the hot air flow and/or at least one of the restrictor devices (44, 46, 48, 50) and/or the additional supply device are controlled in dependence on all set desired temperatures and desired strengths such that the respective temperature controlled air flow substantially has the pre-set desired temperature and the pre-set flow strength for each of the regions (14, 14′, 14″, 14′″).

2. A method in accordance with claim 1 characterized
in that at least one of the regions for which a first of the two temperature controlled air flows is provided is divided into two part regions;
in that the strengths of at least two part region air flows are controlled for those part regions which are formed by dividing the first temperature controlled air flow and by a restriction of the part region air flows by respectively corresponding controllable restrictor devices (44, 46, 48, 50);
in that, instead of the desired temperature and the desired strength of the first air flow, a common desired temperature and respectively a desired strength of the part region air flows are set and the desired strength of the first air flow is determined from the desired strengths of the part region air flows and its desired temperature is determined from the common desired temperature; and
in that the strength of the cold air flow and/or of the hot air flow and/or at least one of the restrictor devices (44, 46, 48, 50) and/or the additional supply device are additionally controlled in dependence on the set desired strengths of the part region air flows such that, for each of the regions and part regions, the temperature controlled air flow or part region air flow respectively substantially has the pre-set desired temperature and the pre-set desired strength.

3. A method in accordance with claim 1 or claim 2, characterized in that the strength of the restriction or of the additional supply of all regional part flows or the strength of the restriction of the part region flows and the strengths and/or temperatures of the cold air flow and of the hot air flow are controlled using a model which links the desired temperatures and desired flow strengths for the regions (14, 14′, 14″, 14′″) or part regions with the strengths of the restriction or of the additional supply of all regional part flows or strengths of the restriction of the part region flows and the strengths and/or temperatures of the cold air flow and of the hot air flow required to achieve these values.

4. A method in accordance with claim 3, characterized
in that characteristic fields are pre-set by which, for respective pre-set desired temperatures and desired flow strengths for the temperature controlled air flow or part region flows for the regions (14, 14′, 14″, 14′″) or part regions, the strengths and/or temperatures of the cold air flow and of the hot air flow and the strengths of the restriction or of the additional supply of the individual regional part flows or strengths of the restriction of the part region flow required to achieve these desired values are defined; and
in that the strength of the restriction or of the additional supply of all regional part flows or of the restriction of the part region flows and the strengths and/or temperatures of the cold air flow and of the hot air flow are controlled using the characteristic fields.

5. A method in accordance with claim 4, characterized in that the strength of the restriction or of the additional supply of at least one regional part flow and/or the strength of the restriction of at least one part region flow and the strengths and/or temperatures of the cold air flow and of the hot air flow are obtained by interpolation or extrapolation from a discrete characteristic field.

6. A method in accordance with any one of claims 2 to 5, characterized in that the model is obtained using measurements.

7. A method in accordance with any one of claims 2 to 6, characterized in that the model is obtained by simulation calculations.

8. A method in accordance with any one of the preceding claims, characterized in that the delivery of a fan (30) generating the cold air flow and hot air flow jointly is controlled to control the strength of the cold air flow and hot air flow.

9. A method in accordance with any one of the preceding claims, characterized in that the respective strengths of the regional part flows are set by controlling the restriction by means of corresponding controllable restrictor devices (44, 46, 48, 50) and without controlling an additional supply.

10. A method of temperature controlling air for at least two regions (14, 14′, 14″, 14′″) of a space, in particular of a passenger compartment of a motor vehicle), in which
a cold air flow and a hot air flow are made available whose temperatures are controllable individually and/or whose strengths are controllable individually or in combination;
at least one respective regional part flow from the cold air flow and from the hot air flow for each of the regions (14, 14′, 14″, 14′″) is formed; and
the respective corresponding regional part flows for each region are restricted and mixed by means of a corresponding controllable restrictor device (44, 46, 48, 50) and/or additional supply device,
wherein the strength of the cold air flow and/or of the hot air flow and/or the restrictor devices (44, 46, 48, 50) and/or additional supply devices are controlled with the method in accordance with any one of claims 1 to 9.

11. A method in accordance with claim 10, characterized
in that at least one of the regions for which a first of the two temperature controlled air flows is provided is divided into two part regions; and
in that two part region flows are formed from the first temperature controlled air flow for the two part regions and are restricted with respectively corresponding controllable restrictor devices,
wherein the strength of the cold air flow and/or of the hot air flow and/or the restrictor devices and/or the additional supply device are controlled with the method in accordance with claim 2 or any one of claims 3 to 9 and claim 2.

12. A method in accordance with claim 10 or claim 11, characterized in that the cold air flow and the hot air flow are formed jointly by means of a controllable fan (30).

13. A method in accordance with any one of claims 10 to 12, characterized in that the hot air flow is formed from at least one regional part flow of the cold air flow.

14. A supply apparatus to make available air flows for at least two regions (14, 14′, 14″, 14′″) of a space, in particular of a passenger compartment of a motor vehicle, having a respective strength and temperature specific to the region, comprising
a cold and a hot air source (30, 32, 34) by means of which a cold air flow and a hot air flow can be produced and discharged via a cold air outlet and/or a hot air outlet of the cold air source and the hot air source (30, 32, 34) and whose temperature is controllable individually and/or whose strengths are controllable individually or in combination,
branching passages (36,38, 38′, 38″, 38′″, 40, 42, 42′, 42″, 42′″) connected to the cold air outlet and the hot air outlet respectively with controllable restrictor devices (44, 46, 48, 50) and/or at least one additional supply device by means of which separately controllable cold air regional part flows and hot air regional part flows can be made available for each of the regions (14, 14′, 14″, 14′″) from the cold air flow and/or hot air flow;
at least one detection device (26, 26′, 26″, 26′″) to respectively detect a desired temperature and a desired strength of the air flow to be supplied separately to the respective region;
a control device (24) connected to the detection device (26, 26′, 26″, 26′″) to control the cold air source and the hot air source (30, 32, 34) and the restrictor devices (44, 46, 48, 50) and/or the additional supply device in dependence on the desired temperatures and the desired strengths of the air flows for the regions (14, 14′, 14″, 14′″) by means of which the cold air source and the hot air source (30, 32, 34) and the restrictor devices (44, 46, 48, 50) and/or the additional supply device can be controlled in dependence on the desired temperatures and/or the desired strengths of the air flows for the regions (14, 14′, 14″, 14′″) such that the strengths and temperatures of the air flows for all regions (14, 14′, 14″, 14′″) substantially agree with the desired strengths and desired temperatures for these regions (14, 14′, 14″, 14′″).

15. A supply apparatus in accordance with claim 14, characterized
in that the supply apparatus is adapted to make available two equally temperature controlled part region air flows for two part regions of one of the regions instead of a temperature controlled air flow for this region;
in that branching channels for cold air and hot air provided for this region open into a passage which branches into part region passages in which a respective controllable restrictor device connected to the control device is arranged;
in that the detection device is made to detect desired strengths and a common desired temperature of the part region flows instead of to detect the desired strength and desired temperature of the air flow to be supplied to the region;
in that the control device for the controlling of the cold air source and the hot air source and the restrictor devices and/or the additional supply device in dependence on the desired temperatures and desired strengths of the air flows for the regions and part regions, by means of which the cold air source and the hot air source and the restrictor devices and/or the additional supply device can be controlled in dependence on the desired temperatures and/or on the desired strengths of the air flows for the regions and the part regions such that the strengths and temperatures of the air flows for all regions and part regions substantially agree with the desired strengths and the desired temperatures for these regions.

16. A supply apparatus in accordance with claim 15, characterized in that the control device (24) has an interface for the detection device and interfaces for the cold air source and the hot air source (30, 32, 34), the restrictor devices (44, 46, 48, 50) and/or the additional supply device, a memory device and a processor connected to the interfaces and to the memory device, wherein a program which is executable with the processor is stored in the memory device to carry out the method in accordance with anyone of claims 1 to 9.

17. A supply apparatus in accordance with claim 15 or claim 16, characterized in that a characteristic field can be stored in a memory device to carry out the method in accordance with any one of claims 3 to 6 or one of claims 7 and 8 and any one of claims 3 to 6.

18. A supply apparatus in accordance with any one of claims 14 to 17, characterized in that the cold air source and the hot air source (30, 32, 34), the restrictor devices (44, 46, 48, 50) and/or the additional supply device and sections of the branching passages (36, 38, 38′, 38″, 38′″, 40, 42, 42′, 42″, 42′″) are combined to form one component up to these devices.

19. A supply apparatus in accordance with any one of claims 14 to 18, characterized in that the cold air source and the hot air source (30, 32, 34) has a fan (30) with a controllable delivery to supply temperature controlled air; and
in that the strength of the cold air flow and of the hot air flow is controllable by control of the delivery of the fan (30).

20. A supply apparatus in accordance with claim 19, characterized in that the hot air flow source (34) is arranged downstream of the cold air source (32) and can be fed by cold air formed by the cold air source (32).

21. A supply apparatus in accordance with any one of claims 14 to 20, characterized in that at least one restrictor apparatus (44, 46, 48, 50) is formed by a section of the corresponding branch passage (36, 38, 38′, 38″, 38′″, 40, 42, 42′, 42″, 42′″) connected to a corresponding outlet of the cold air source and of the hot air source (30, 32, 34) and by a throttle flap (44, 46) which is arranged in the section or at one of its ends and whose position is controllable.

22. A supply apparatus in accordance with any of claims 14 to 21, characterized in that at least one restrictor device has a controllable film valve.

23. A computer program comprising program code means to carry out the method in accordance with any one of claims 1 to 9 when the program is executed on a computer.

24. A computer program product comprising program code means which are stored on a computer readable data carrier to carry out the method in accordance with any one of claims 1 to 9 when the computer program product is executed on a computer.
